(19) United States
(12) Patent Application Publication
(10) Pub. No.: US 2006/0114956 A1
(43) Pub. Date: Jun. 1, 2006

(54) High power high pulse repetition rate gas discharge laser system bandwidth management

(76) Inventors: Richard L. Sandstrom, Encinitas, CA (US); William N. Partlo, Poway, CA (US); Daniel J.W. Brown, San Diego, CA (US); J. Martin Algots, San Diego, CA (US); Fedor Trintchouk, San Diego, CA (US)

Correspondence Address: William C. Cray;Cymer, Inc., Legal Dept., MS/4-2C, 17075 Thornmint Court, San Diego, CA, 92127-2413, US

(21) Appl. No.: 11/000,571

(22) Filed: Nov. 30, 2004

(51) Int. Cl. H01S 3/22

(52) U.S. Cl. 372/55

(57) ABSTRACT

A line narrowing apparatus and method for a narrow band DUV high power high repetition rate gas discharge laser producing output laser light pulse beam pulses in bursts of pulses is disclosed, which may comprise a dispersive center wavelength selection optic contained within a line narrowing module, selecting at least one center wavelength for each pulse determined at least in part by the angle of incidence of the laser light pulse beam containing the respective pulse on a dispersive wavelength selection optic dispersive surface; a first dispersive optic bending mechanism operatively connected to the dispersive center wavelength selection optic and operative to change the curvature of the dispersive surface in a first manner; and, a second dispersive optic bending mechanism operatively connected to the dispersive center wavelength selection optic and operative to change the curvature of the dispersive surface in a second manner. The first manner may modify a first measure of bandwidth and the second manner may modify a second measure of bandwidth such that the ratio of the first measure to the second measure substantially changes. The first measure may be a spectrum width at a selected percentage of the spectrum peak value (FWX % M) and the second measure may be width within which some selected percentage of the spectral intensity is contained (EX %). The first dispersive optic bending mechanism may change the curvature of the dispersive surface in a first dimension and the second in a second dimension generally orthogonal to the first dimension. The laser system may comprise a beam path insert comprising a material having an different index of refraction and an index of refraction thermal gradient opposite from that of a neighboring optical element. The first dispersive optic bending mechanism may change the curvature of the dispersive surface in a first dimension and the second a second dimension generally parallel to the first dimension. An optical beam twisting element in the lasing cavity may optically twist the laser light pulse beam to present a twisted wavefront to the dispersive center wavelength selection optic. Bending may change the curvature and wavelength selection, e.g., in a burst may create two center wavelength peaks to select FWX % M and EX % independently.

### RELATED APPLICATIONS

This application is related to U.S. application Ser. No. ______ filed on the same day as this application, entitled LINE NARROWING MODULE, Attorney Docket No. 2004-0056-01, assigned to the common assignee of the present application, the disclosure of which is hereby incorporated by reference. This application is also related to co-pending U.S. application Ser. No. 10/956,784, entitled RELAX GAS DISCHARGE LASER LITHOGRAPHY LIGHT SOURCE, filed on Oct. 1, 2004, and assigned to the common assignee of the present application, the disclosure of which is hereby incorporated by reference.

### FIELD OF THE INVENTION

The present invention relates to high power high repetition rate gas discharge excimer and molecular fluorine laser systems that produce DUV light suitable for such applications as integrated circuit photolithography photoresist exposures with the attendant strict controls on certain parameters of the output laser light pulses in an output laser light pulse beam.

### BACKGROUND OF THE INVENTION

In high power high pulse repetition rate gas discharge laser systems producing an output laser light pulse beam of pulses in bursts of pulses for use as a light source for manufacturing equipment treating the surface of a workpiece, e.g., a wafer in a semiconductor integrated circuit lithography tool to expose photoresist on the wafer, high optical fluence induces optical non-uniformities in propagation media. Developed index of refraction gradients in LNM prism(s), chamber window(s) and purge gas (, e.g., helium) lead to laser wavefront distortion which results also in optical spectrum broadening. The condition of the gas in the lasing chamber, e.g., F₂ content can also impact the laser performance, including bandwidth, e.g., due to changing laser light pulse beam wavefront. Applicants propose solutions to these problem according to aspects of an embodiment of the present invention.

It is known in the art to employ within a laser resonance cavity, e.g., defined as a laser chamber between a partially reflective output coupler and a fully reflective mirror forming the cavity, e.g., in a single chamber laser oscillator or an oscillator portion of a two chambered laser system having a oscillator portion feeding a seed beam into an amplifying portion, e.g., a power amplifier in a master oscillator power amplifier (“MOPA”) configuration, a line narrowing module. the line narrowing module is positioned and adapted to select a desired center wavelength a round a narrow band of wavelengths, with the bandwidth of the narrow band also being carefully selected ordinarily to be of as narrow a bandwidth as possible, e.g., for lithography uses where chromatic aberrations in the lenses of a scanning lithography photo-resist exposure apparatus can be critical, but also to, e.g., be within some range of bandwidths, i.e., neither to large not too small, also, e.g., for photo-lithography reasons, e.g., for optimizing and enabling modem optical proximity correction techniques commonly used in preparing masks (reticles). For such reasons control of bandwidth in more than just a “not-to-exceed” mode is required, i.e., control is required within a narrow range of “not-to-exceed” and “not-to-go-below” specified values of bandwidth, and including with these requirements stability pulse to pulse.

Currently line narrowing modules contain a grating as a dispersive optical element, e.g., an eschelle grating in a Littrow arrangement with a selected graze angle for returning a selected center wavelength to the laser resonator cavity in which the line narrowing module is located. Over time, in a fluence of high energy DUV light such as are present in high power gas discharge excimer or molecular fluorine laser systems, e.g., used in semiconductor manufacturing photolithography as the DUV light source capable of delivering the very high pulse repetition rate very high energy pulse laser beams needed from such a light source, the optically dispersive surfaces of the grating, or at least a reflective coating, usually of aluminum, deteriorates. This deterioration can reach the point that the center wavelength selection and/or line narrowing can no longer be accomplished within required specifications. Applicants according to aspects of an embodiment of the present invention propose a solution to this end of life problem that will improve overall laser system efficiency through improving the cost of operation over the laser system life by elongating the useful life of the grating.

It will also be understood that a number of factors impact the ability of gas discharge laser systems to repeatably produce output laser light pulse beams with pulses containing the right bandwidth within the specified range. These include a number of factors that can modify the wavefront of the laser light pulse beam within the laser system, e.g., into a line narrowing module within the laser oscillation cavity, either for a single chamber laser or in a combination of oscillator chamber and another oscillator chamber without line narrowing or an amplifier chamber that is not an oscillator, e.g., in the former case a master oscillator power oscillator system (“MOPO”) or in the latter case a master oscillator power amplifier system (“MOPA”). Often it is desirable to modify each of the bandwidths of the laser output light pulse beam pulse, FWHM and E95 separately. Existing ways of modifying bandwidth tend to modify both FWHM and E95 in the same way, i.e., both decreasing or increasing and remaining at a relatively constant ratio one to the other, as shown, e.g., in FIGS. 1A and B. Applicants propose according to aspects of an embodiment of the present invention modification of FWHM and E95 where a relatively linear and continuously variable ratio between the two may be obtained to selectively modify one with respect to the other without the just noted relatively constant difference between the two.

A characteristic of gas discharge laser systems which can impact the ability to maintain bandwidth stability is the divergent nature of the laser light pulse beam which is transiting through the system, e.g., through a line narrowing module (“LNM”), sometimes also referred to as a line narrowing package (“LNP”), in and oscillation cavity where center wavelength and bandwidth are determined or partly determined for the ultimate laser system output light pulse beam of pulses. In one case the laser system may comprise a single chamber with an resonating oscillator cavity and the line narrowing module in the cavity and in another, e.g., a two system, e.g., a master oscillator power amplifier (“MOPA”) laser system the LNM may be in the cavity of the master oscillator portion of the system and determines the bandwidth of the laser light pulse beam of pulses exiting the MO, and in part therefore also determines the bandwidth of the ultimate output laser light pulse beam of pulses exiting the laser system as a whole. Applicants propose, according to aspects of embodiments of the present invention improvements in this bandwidth control and bandwidth stability control, pulse to pulse over a burst and burst to burst.

Bandwidth measurements are used in laser control systems for various purposes and the ability to produces laser output light pulses that are of a given bandwidth, e.g., 0.12 pm, perhaps within a relatively narrow band, e.g., about ±0.05 pm FWHM or a corresponding width measured as, e.g., E95 is very important, especially for such uses as light sources for integrated circuit photolithography. It is understood that FWHM (“full width half maximum”) is a measurement of bandwidth at some percentage of the peak value, in this case 50% of the peak value for FWHM, but may just as well be some other percentage of the peal value, e.g., 25% (“FW25M”) or 75% (“FW75M”) and the use of FWHM in this application and the appended claims, unless otherwise specifically indicated, is intended to cover all forms of this percentage of peak value way of indicating bandwidth. It will also be understood that E95 is a measurement of bandwidth at the width within which is contained some percentage of the integral of the spectral intensity contained within a spectrum, e.g., 95% for E95, on either side of the center wavelength of the spectrum. This may just as well be some other percentage, e.g., 25% (“E25”) or 75% (“E75”) and the use of E95 in this application and claims unless otherwise clearly so indicated is intended to cover all forms of this manner of indicating bandwidth, as opposed to the FWHM method.

In the past it has been known to pull the grating into something like a catenary, as discussed in U.S. Pat. No. 5,095,492, entitled SPECTRAL NARROWING TECHNIQUE, issued to Sandstrom on Mar. 10, 1992, and assigned to the common assignee of the present application, the disclosure of which is hereby incorporated by reference. It is also known in the art to utilize a bandwidth control device in another form, as discussed, by way of example, in U.S. Pat. No. 6,212,217, entitled SMART LASER WITH AUTOMATIC BEAM QUALITY CONTROL, issued to Erie et al. on Apr. 3, 2001, and assigned to the common assignee of the present application, this disclosure of which is hereby incorporated by reference. Applicants propose according to aspects of an embodiment of the present invention an improved wavefront control using aspects of these bandwidth control devices.

U.S. Pat. No. 6,760,358, issued to Zimmerman, et al. on Jul. 6, 2004, entitled LINE-NARROWING OPTICS MODULE HAVING IMPROVED MECHANICAL PERFORMANCE, the disclosure of which is hereby incorporated by reference, discloses:
An apparatus for adjusting an orientation of an optical component mounted within a laser resonator with suppressed hysteresis includes an electromechanical device, a drive element, and a mechano-optical device coupled to the mounted optical component. The drive element is configured to contact and apply a force to the mechano-optical device in such a way as to adjust the orientation of the mechano-optical device, and thereby that of the optical component, to a known orientation within the laser resonator. The optical component is mounted such that stresses applied by the mount to the optical component are homogeneous and substantially thermally-independent.

### SUMMARY OF THE INVENTION

A line narrowing apparatus and method for a narrow band DUV high power high repetition rate gas discharge laser producing output laser light pulse beam pulses in bursts of pulses is disclosed, which may comprise a dispersive center wavelength selection optic contained within a line narrowing module, selecting at least one center wavelength for each pulse determined at least in part by the angle of incidence of the laser light pulse beam containing the respective pulse on a dispersive wavelength selection optic dispersive surface; a first dispersive optic bending mechanism operatively connected to the dispersive center wavelength selection optic and operative to change the curvature of the dispersive surface in a first manner; and, a second dispersive optic bending mechanism operatively connected to the dispersive center wavelength selection optic and operative to change the curvature of the dispersive surface in a second manner. The first manner may modify a first measure of bandwidth and the second manner may modify a second measure of bandwidth such that the ratio of the first measure to the second measure substantially changes. The first measure may be a spectrum width at a selected percentage of the spectrum peak value (FWX % M) and the second measure may be width within which some selected percentage of the spectral intensity is contained (EX %). The first manner may change the cylindrical curvature of the dispersive surface and the second manner may change the catenary curvature of the dispersive surface. At least one of the first and second bending mechanisms may be controlled by a wavefront controller during a burst based upon feedback from a beam parameter detector detecting a beam parameter in at least one other pulse in the burst of pulses and the controller providing the feedback based upon an algorithm employing the detected beam parameter for the at least one other pulse in the burst. The line narrowing module may comprise a dispersive center wavelength selection optic contained within a line narrowing module, selecting at least one center wavelength for each pulse determined at least in part by the angle of incidence of the laser light pulse beam containing the respective pulse on a dispersive wavelength selection optic dispersive surface; a first dispersive optic bending mechanism operatively connected to the dispersive center wavelength selection optic and operative to change the curvature of the dispersive surface in a first dimension; a second dispersive optic bending mechanism operatively connected to the dispersive center wavelength selection optic and operative to change the curvature of the dispersive surface in a second dimension generally orthogonal to the first dimension. The change of curvature in the first dimension may modify a first measure of bandwidth and the change of curvature in the second dimension may modify a second measure of bandwidth such that the ratio of the first measure to the second measure substantially changes. The change of curvature in the first dimension may changes the cylindrical curvature in the first dimension and the change of curvature in the second dimension may change the cylindrical curvature in the second dimension, or the catenary curvature in the first dimension and the catenary curvature in the second dimension, or one of the cylindrical curvature and the catenary curvature in the first dimension and the other of the cylindrical and the catenary curvature in the second dimension. The narrow band DUV high power high repetition rate gas discharge laser producing output laser light pulse beam pulses may comprise a beam path insert comprising a second material having a second index of refraction and a second index of refraction thermal gradient opposite from the first index of refraction thermal gradient and placed in the beam path and subject to essentially the same ambient environment as a neighboring optical element. The beam path insert may comprise a thin plate. The first material may comprise MgF₂ and the second material may comprise an amorphous form of silicon, such as fused silica. The optical elements may be selected from a group containing prisms, windows and dispersive optical elements. The beam path insert may have a surface of incidence and a surface of transmittance at least one of the surface of incidence and the surface of transmittance being coated with an anti-reflecting coating to minimize Fresnel losses through the beam path insert. The thickness of the beam path insert may be selected based upon the thickness of the neighboring optical element through which the highest fluence passes and the ratio of the volume absorption coefficient of the first material and the second material. The line narrowing module may comprise a dispersive center wavelength selection optic contained within a line narrowing module, selecting at least one center wavelength for each pulse determined at least in part by the angle of incidence of the laser light pulse beam containing the respective pulse on a dispersive wavelength selection optic dispersive surface; a first dispersive optic bending mechanism operatively connected to the dispersive center wavelength selection optic and operative to change the curvature of the dispersive surface in a first dimension; a second dispersive optic bending mechanism operatively connected to the dispersive center wavelength selection optic and operative to change the curvature of the dispersive surface in a second dimension generally parallel to the first dimension. The laser system for producing a narrow band DUV high power high repetition rate gas discharge laser output laser light pulse beam pulses in bursts of pulses may comprise a resonant lasing cavity; a dispersive center wavelength selection optic contained within a line narrowing module, within the lasing cavity, selecting at least one center wavelength for each pulse determined at least in part by the angle of incidence of the laser light pulse beam containing the respective pulse on a dispersive wavelength selection optic dispersive surface; an optical beam twisting element in the lasing cavity optically twisting the laser light pulse beam to present a twisted wavefront to the dispersive center wavelength selection optic. The optical beam twisting element may comprises a first cylindrical lens and a second cylindrical lens in telescoping arrangement. At least one of the first and second cylindrical lens may be rotatable about a transverse centerline axis of the at least one of the first and second cylindrical lens. The first cylindrical lens may be rotatable about a transverse centerline axis of the first cylindrical lens and the second cylindrical lens may be rotatable about a transverse centerline axis of the second cylindrical lens. The line narrowing module for a narrow band DUV high power high repetition rate gas discharge laser producing output laser light pulse beam pulses in bursts of pulses may comprise a dispersive center wavelength selection optic contained within a line narrowing module, selecting at least one center wavelength for each pulse determined at least in part by the angle of incidence of the laser light pulse beam containing the respective pulse on a dispersive wavelength selection optic dispersive surface; a dispersive optic bending mechanism operatively connected to the dispersive center wavelength selection optic and operative to change the curvature of the dispersive surface; an optical bandwidth selection element operative to modify the effective spectrum of the laser light pulse beam by creating a first spectrum centered at a first center wavelength and a second spectrum centered at a second center wavelength separated from the first center wavelength by a selected displacement that is small enough for the first and the second spectra to substantially overlap. The optical bandwidth selection element may comprise a dithered tuning mechanism, e.g., a tuning mirror or a tuning prism, that selects the first center wavelength for some pulses in a burst and the second center wavelength for other pulses in the burst to provide an effective integrated spectrum for the burst containing the two selected overlapping center wavelength spectra, or a variably refractive optical element that defines a first angle of incidence of a first portion of the laser light pulse beam on the dispersive wavelength selective optic and a second angle of incidence for a second portion of the laser light pulse beam, spatially separate from the first portion, on the dispersive wavelength selective optic. The variably refractive optical element may comprise a cylindrical lens having a longitudinal cylinder centerline axis generally parallel to a centerline axis of a cross section of the laser light pulse beam, and variably insertable into the path of the first portion of the laser light pulse beam. The bending mechanism primarily modifies a first measure of bandwidth and the optical bandwidth selection element primarily modifies a second measure of bandwidth. The first measure may be EX % and the second measure may be FWX % M.

### BRIEF DESCRIPTION OF THE DRAWINGS

FIGS. 1A and 1B show graphs of FW and the E95 bandwidth changes as a bandwidth control device is adjusted;

FIG. 2 shows partly schematically a prior art active bandwidth control device as discussed in U.S. Pat. No. 5,095,492, referenced above;

FIG. 3 shows a prior art bandwidth control device as discussed in U.S. Pat. No. 6,212,217;

FIG. 4 is a graph illustrating the effects of combining bandwidth control devices bending the grating in different modes according to aspects of an embodiment of the present invention;

FIG. 5 shows schematically an apparatus for imparting multiple distortions to the grating a the same time according to aspects of an embodiment of the present invention;

FIG. 6 shows partly schematically a line narrowing module according to aspects of an embodiment of the present invention;

FIGS. 6A-6D illustrate the distortive impact of application of an exemplary pair of forces to the grating with the apparatus of FIG. 5 according to aspects of an embodiment of the present invention;

FIG. 7 is a chart of changes in bandwidth as measured in different manners according to aspects of an embodiment of the present invention;

FIG. 8 is a chart similar to that of FIGS. 1A and 1B;

FIG. 9 is a chart of simulated wavelength peak separations and resulting in the impact on E95 and FWHM shown in FIG. 7.

FIG. 10 shows schematically a laser system according to aspects of an embodiment of the present invention;

FIG. 11 shows partly schematically an optical beam twisting element according to aspects of an embodiment of the present invention;

FIG. 12 shows an example of a twisted beam profile created by the optical beam twisting element of FIG. 11;

FIG. 13 shows an example of the effect of beam twisting on a measure of bandwidth; and

FIG. 14 shows the orientation of the two lenses rotated with respect to each other according to an aspect of an embodiment of the present invention.

### DETAILED DESCRIPTION OF PREFERRED EMBODIMENTS

The need for active control of laser bandwidth, e.g., of either or both of FWHM and E95, has been requested by applicants' assignee's customers for its laser system products and many of the end users for such products. Applicants propose ways for better bandwidth control and also to control both FWHM and E95, independently, according to aspects of an embodiment of the present invention, e.g., by using two independent adjustments so that both parameters can be adjusted and maintained within a set range of values. One of the existing ways of modifying bandwidth, as illustrated in FIGS. 1A and 1B utilizes, e.g., a bandwidth control device (“BCD”), e.g., as presently implemented in the laser's line narrowing module (“LNM”), e.g., in applicants assignee's 7XXX and XLA-XXX series of products. The BCD affects the cylindrical curvature of a dispersive center wavelength selection optical element, which also produces a bandwidth of some width FWHM and E95, e.g., the grating in, e.g., and eschelle grating in Littrow configuration as used in line narrowing modules in the above referenced laser products. Changes in the dispersive surface of the grating, e.g., the cylindrical curvature of the grating impact both the FWHM and E95 of the laser's bandwidth. An example of this effect is shown in FIGS. 1A and B where the raw values (signal out of a photo diode array indicative of a measured width) and deconvolved values (processed to remove from the signal the contribution of the metrology instrument, e.g., an etalon) are shown for FWHM and E95 for various cylindrical curvatures of the BCD dispersive surface, as indicated by turns on a BCD tensioning/compressing force application device as is known in the art.

As one can seen in FIGS. 1A and 1B, both the FWHM and the E95 bandwidth change as the BCD is adjusted, in the same direction and in about the same fashion so that the ratio of one to the other remains relatively constant and changing the one changes the other in about the same way to about the same degree. According to aspects of an embodiment of the present invention applicants propose to utilize differing wavefront shapes, e.g., by adding another wavefront curvature, besides, e.g., a cylindrical curvature, imparted to the grating to produce different FWHM and E95 variations.

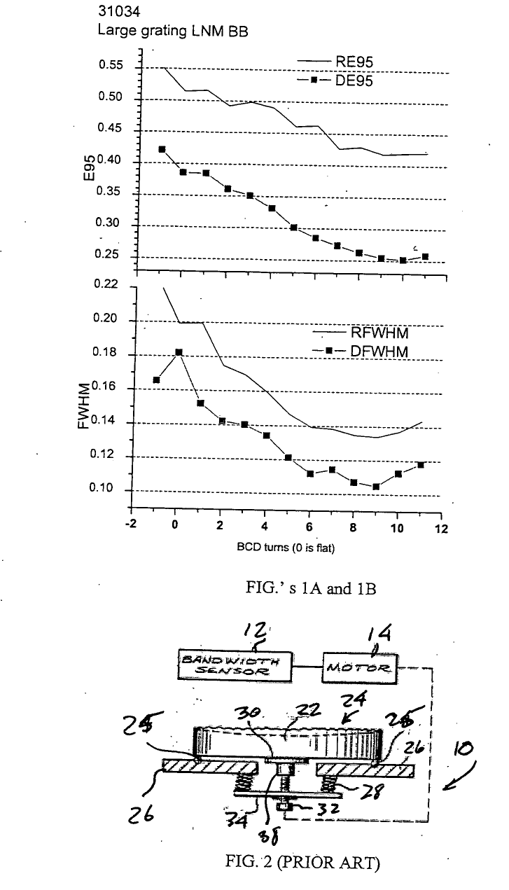

One method for imparting a different wavefront shape, and thus a different FWHM and E95 variation, is to “pull” or “push” on the grating at its center. This action imparts a caternary-like wavefront curvature, which applicants have simulated to produce a different FWHM and E95 impact than the known currently in use BCD. In the past it has been known to pull the grating into something like a catenary shape, as discussed in U.S. Pat. No. 5,095,492, entitled SPECTRAL NARROWING TECHNIQUE, issued to Sandstrom on Mar. 10, 1992, and assigned to the common assignee of the present application, the disclosure of which is hereby incorporated by reference. This form of bandwidth control device is illustrated in FIG. 2 taken from that patent. The normalized equation for the shape of the bent grating as described is y(x)=3/2(x/L)²−1/2(x/L)³, where x is the distance from the center, 2L is the length of the grating, y is the normalized deviation of the surface (y=1 at the ends, and y=0 at the center). This does not form a true catenary, however, which is a cosh(x) function. As used in the present application, however, catenary, unless otherwise clearly so indicated, is meant to be broad enough to cover both the true catenary cosh(x) function and the catenary-like function created by the use of a bandwidth control device to impart the catenary-like curvature to the grating as descibed in the present application.

As is partly schematically shown in FIG. 2 a grating 22 may be contained in a line narrowing module 10, and be actively controlled for bandwidth modification by changing the shape of the grating 22, e.g., in the longitudinal axis of the grating 22, to account for the wavefront of the laser light pulse beam incident on the dispersive surface 24 of the grating 22, e.g., under the control of a bandwidth sensor 12 and a servo motor 14. The grating assembly may also include a ball mounting 25, which may be one of three arranged in a triangle or four arranged generally at the corners of the elongated rectangularly shaped body of the grating 22 to interface the grating 22 with a base plate 26. The grating 22 may have attached to its rear surface opposite the dispersive surface 24 an attachment plate 30 and the attachment plate 30 may be attached to a force plate 34 by a pair of springs 28. The attachment plate may be pulled upon (or pushed upon) by a force application screw 32 that may be threaded into a sleeve 38 integral with the force application plate 30 to modify the curvature of the dispersive surface 24 of the grating 22. The threaded screw 32 may be actively rotated by the motor 14 to actively modify the shape of the dispersive surface 24 of the grating 22.

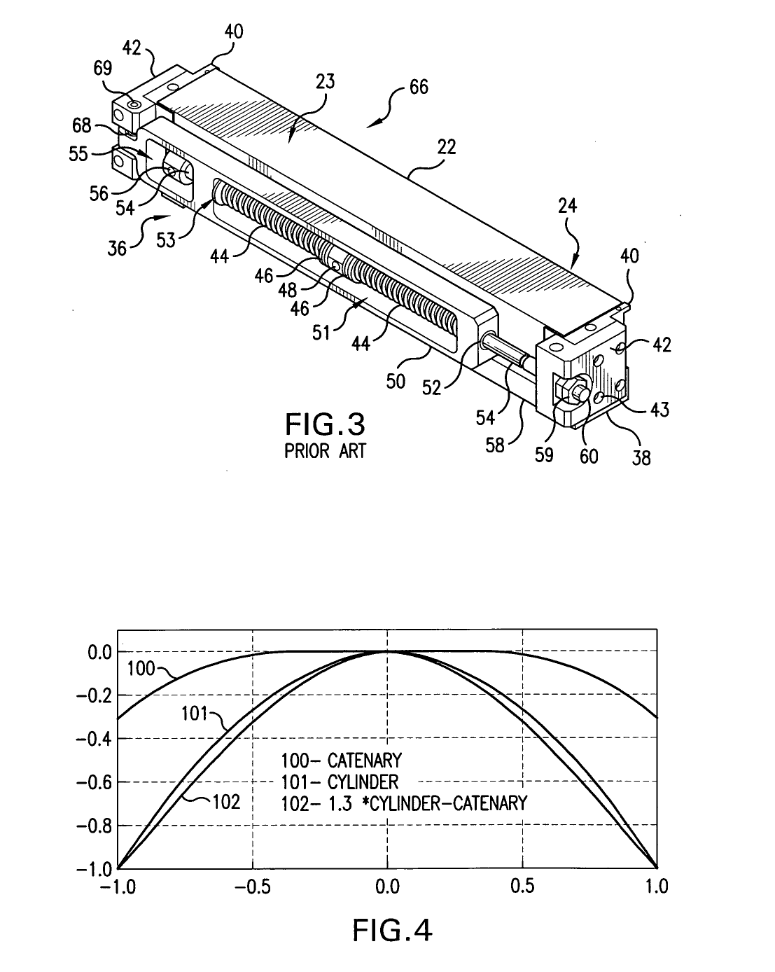

Applicants propose to combine this form of bandwidth control device with another form of bandwidth control device known in the art, as referenced above relating to U.S. Pat. No. 6,212,217, entitled SMART LASER WITH AUTOMATIC BEAM QUALITY CONTROL, issued to Erie et al. on Apr. 3, 2001, as illustrated in FIG. 3. A version of this type of bandwidth control device 66 is currently in use in laser systems sold by applicants' assignee, e.g., in 7XXX and XLA-XXX series laser systems. The bandwidth control device 66 of this type, may include, e.g., the grating 22 with its dispersive surface 24, which may be attached to a end plate 40, e.g., by gluing. The end plates 40 may in turn each be attached to a force plate 42, e.g., by screws 43. The grating 22 and in turn its dispersive face 24 may be curved, e.g., into a cylindrical concave or convex shape by the application of tensile or compressive force to the force application plates 42 through a specially designed force application unit 36, which is designed to variably apply spring tension or compression to the end force plates 43 in a controlled fashion without breaking the grating 22. The force application unit may comprise a compression spring 44 attached through a thrust bearing 46 to a piston 48. The ends of the compression spring 44 are held within a yoke 50, within a cut-out portion 51 of the yoke 50, by washers 53, with the piston threadedly attached to a force setting rod 54. the force rode passes through the respective ends of the cut out portion 51 of the yoke 50 through linear bearings 52. The force rod 54 has at one end in a second cut-out portion 55 of the yoke 50 a travel limiting piston 56 and at the other end is attached to one force application plate 42 by a lock nut 59 and a socket nut 60. The other end of the yoke 50 is attached to the other force application plate 42 by a pivot pin 69 passing through a protrusion on the yoke in a radial bearing 68. Also shown in FIG. a base plate 58 for the grating that may be made or a suitable material having a low (essentially zero) coefficient of thermal expansion and similar in that respect to the grating itself, such as Invar. The grating may be made, e.g., of a very low coefficient of thermal expansion material, e.g., ULE made by Corning. Generally speaking, care must be taken to minimize undesirable effects cause by thermal and mechanical stresses on the grating, e.g., by selecting materials such as ULE and utilizing such things as flexured mountings and the like techniques.

In operation, according to aspects of an embodiment of the present invention, the grating 22 may be changed in curvature in two different ways simultaneously, e.g., by the use of a bandwidth control device of the type shown illustratively in FIG. 3, to, e.g., bend the grating 22 dispersive surface 24 in a cylindrical manner, e.g., when the force setting rod 54, to, e.g., move the piston 48 away from a center point, so that, e.g., the right hand spring 44, as shown in FIG. 3, pulls the yoke 50 to the left as shown in FIG. 3 and the left-hand spring 44 pushes the yoke to the left as shown in FIG. 3 to push the end plates 43 and the attached plates 40 away from each other, with the resultant concave cylindrical curvature imparted to the grating 22 dispersive surface 24, and vice-versa for rotation of the shaft 54 in the opposite direction for reducing the concave cylindrical curvature of the dispersive surface 24 and eventually imparting convex curvature to the dispersive surface 24.

At the same time, a second form of curvature may be imparted to the grating 22 dispersive surface 24, e.g., a catenary-like curvature as described above, by, e.g., attaching a second yoke (not shown) to take the place of the attachment plate 30 illustrated in FIG. 2, orthogonal t the yoke 50 shown illustratively in FIG. 3. This may be done, e.g., by a U-shaped yoke (not shown) attached to the sides 23 of the grating 22 for imparting the force illustrated in FIG. 2 and the resultant catenary-like curvature.

FIG. 4 illustrates the resultant combined curvature imparted to the dispersive surface 24, e.g., a catenary curvature 100 and a cylindrical curvature 101 combined into a 1.3*cylindrical-catenary curve 102. In this manner two separate indications of bandwidth, e.g., FWHM and E95 can be separately modified by the distinct separate type of curvature imparted to the dispersive surface 24 of the grating 22. According to aspects of an embodiment of the present invention, the curvatures may have opposite signs, in which event the net shape is determined by the difference in the two curves: cylinder vs. catenary-like. The net wavefront is rolled off at the ends as illustrated in FIG. 4.

According to aspects of an embodiment of the present invention the flatness and magnitude of the net wavefront can be dialed in, e.g., by a coordinated application of the two orthogonal BCD actions. The “normal” cylindrical BCD action from the illustrated bandwidth control device of FIG. 3 remains intact for correcting system curvature.

According to another aspect of an embodiment of the present invention the catenary-like second curvature mode can be imparted upon the grating 22 dispersive surface by, e.g., adding an orthogonal spring mechanism (not shown) between essentially the center of the longitudinal and lateral span of the grating 22 and the yoke 50 as illustrated in FIG. 3, and the back of the grating 22 which pushes and pulls on the grating 22 orthogonal to the BCD as illustrated in FIG. 3. In such an embodiment, the stiffness of the rod 54 may have to be enhanced to take the orthogonal loading.

According to another aspect of an embodiment of the present invention, a second method of affecting a change in grating 22 dispersive surface 24 interaction with the laser light pulse beam wavefront in addition to utilizing the standard BCD assembly as illustrated in FIG. 3 may be, e.g., to use what a top mounted or vertical BCD assembly (not shown). This type of BCD assembly (not shown) can be, e.g., the same as or similar to this standard BCD assembly, except that it may be mounted in a different orientation to the dispersive surface 24 of the grating 22, e.g., on the top of the grating 22, i.e., in a plane parallel to one of the side surfaces 23 rather than the back of the grating body 22 as illustrated in FIG. 3. This arrangement and orientation can then impart a cylindrical curvature in the vertical direction, as illustrated in FIG. 3, corresponding to the direction of the groove orientation across the dispersive surface 24 of the grating 22, rather than the horizontal direction. A cylindrical curvature in the vertical direction on a grating can be used to create, e.g., an S-shaped wavefront in the dispersion direction. According to aspects of an embodiment of the present invention applicants expect that the S-shaped wavefront will also have different FWHM and E95 BW changes versus simply setting the existing BCD setting to a given value (i.e., number of turns on the setting rod 54.

Either method described above or combinations of them can be used to affect a laser system's FWHM and E95 in a manner different from the standard BCD adjustments currently used. Once this additional actuator(s) is made available, coordinated adjustments of the actuators can be used to independently control the laser's FWHM and E95 BW.

According to aspects of an embodiment of the present invention several methods of optically controlling the laser's BW (FWHM and E95) are suggested. Applicants propose that all such methods be used, e.g., alone or in combination each other and/or with the standard BCD for independent control of FWHM and E95. These methods include:
1. High frequency line-center dither, e.g., to obtain a burst wide effective spectrum with two overlapping peaks;
2. Top mounted BCD;
3. Center pull horizontal BCD; and,
4. Insertable cylindrical lens (or any of the other RELAX optical methods) to obtain the overlapping peaks.

Items 2 and 3, as discussed above, are methods for producing a wavefont curvature on the grating dispersive surface 24 that is different from the cylindrical curvature produced by the standard BCD. The top mounted BCD produces an S-shaped wavefront in the dispersion direction and the center pull horizontal BCD produces a catemary-like wavefront in the dispersion direction. These wavefronts are contemplated to be useful since, if different enough, when used in combination with the standard BCD, they can provide independent control of FWHM and E95.

The impact to the laser spectrum from the fourth method, insertable cylindrical lens, has been simulated taking a typical spectrum taken during Rick's E95 monitor work for NL-7000 and shifting it by various amounts. Spectra created in this way are shown in the graph of.

A shift of 0.3 pm begins to show itself for this NL-7000 spectrum of 0.3 pm FWHM (non-deconvolved). Upon first inspection, the insertable cylindrical lens concept according to aspects of an embodiment of the present invention appears to applicants to be effective in affecting the FWHM and E95 values in different ways than the standard BCD curves. The calculated FWHM and E95 changes to this NL-7000 spectrum vs. spectral shift are shown in FIG. 7.

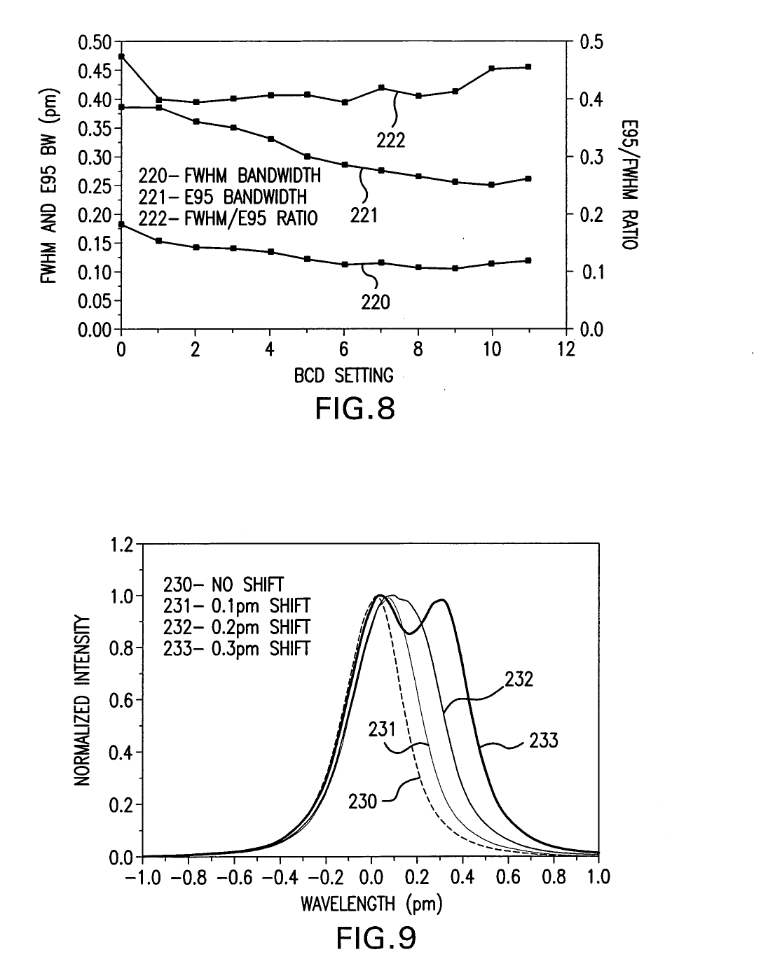

The ratio of E95/FWHM changes by almost a factor of two as the separation is changed from 0 pm to 0.3 pm. In a similar laser configuration. For this case the ratio of E95/FWHM remains relatively stable as the BCD value covers a wide range up to around 9 turns which according to currently used BCDs in applicants' assignee's laser systems is around an optimal amount for bandwidth control. Above 9 turn is, as shown in FIGS. 1A and 1B and FIG. 8, the ratio begins to significantly change. In the region of relatively constant ratio, according to aspects of an embodiment of the present invention, applicants propose to tune to the desired, e.g., E95 value using the BCD and then adjust the desired, e.g., FWHM with the insertable cylindrical lens. According to aspects of an embodiment of the present invention iteration may be utilized to hit an exact value for each, or the use of an orthogonalization algorithm similar to that utilized for beam delivery units (“BDUs”) mirrors, e.g., for position vs. pointing can be utilized.

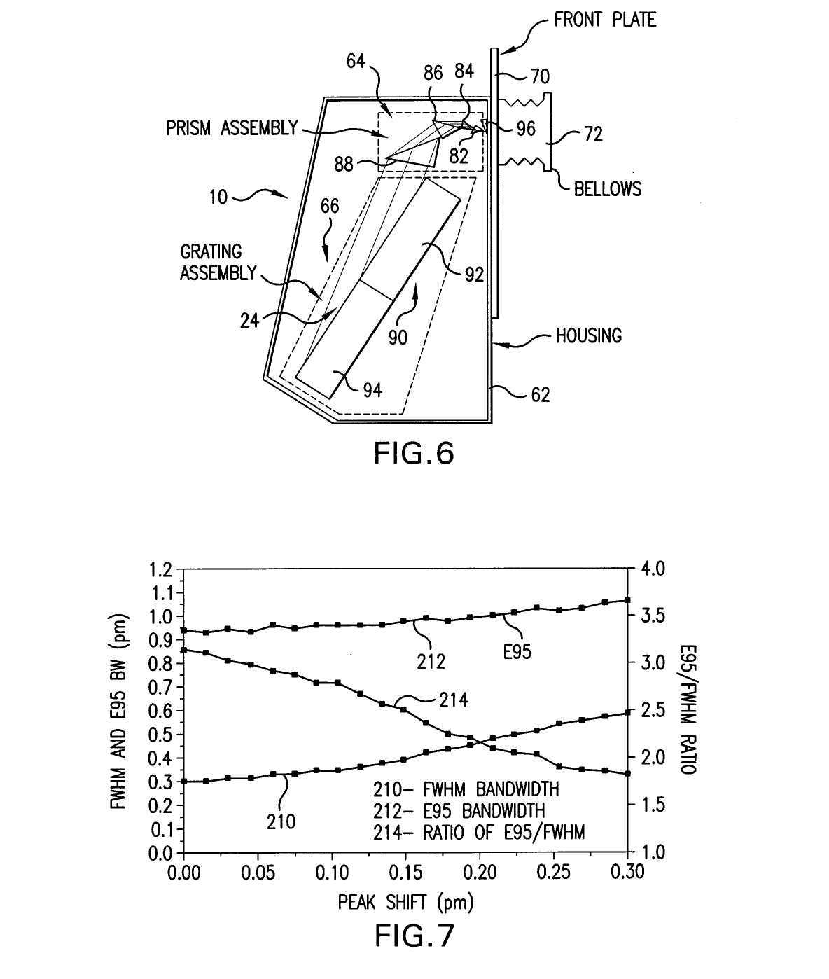

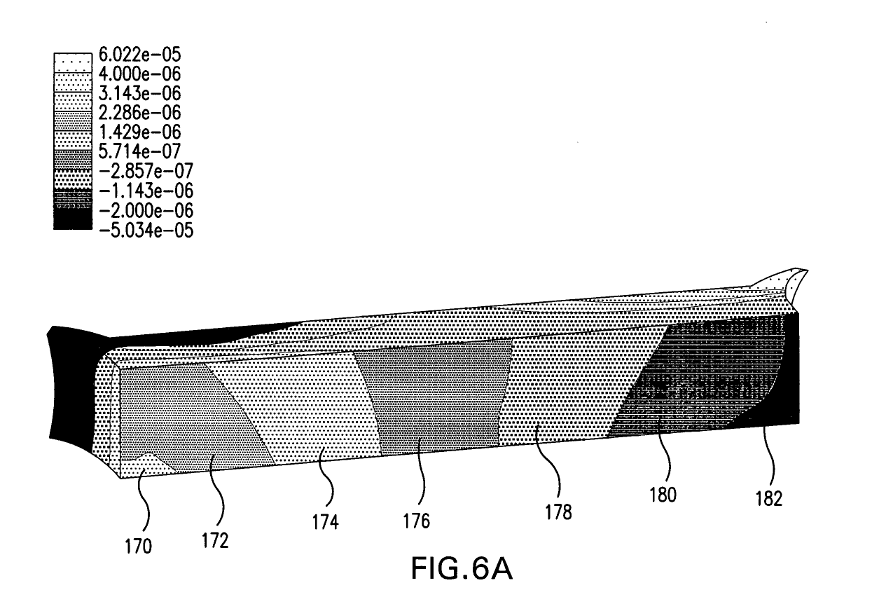

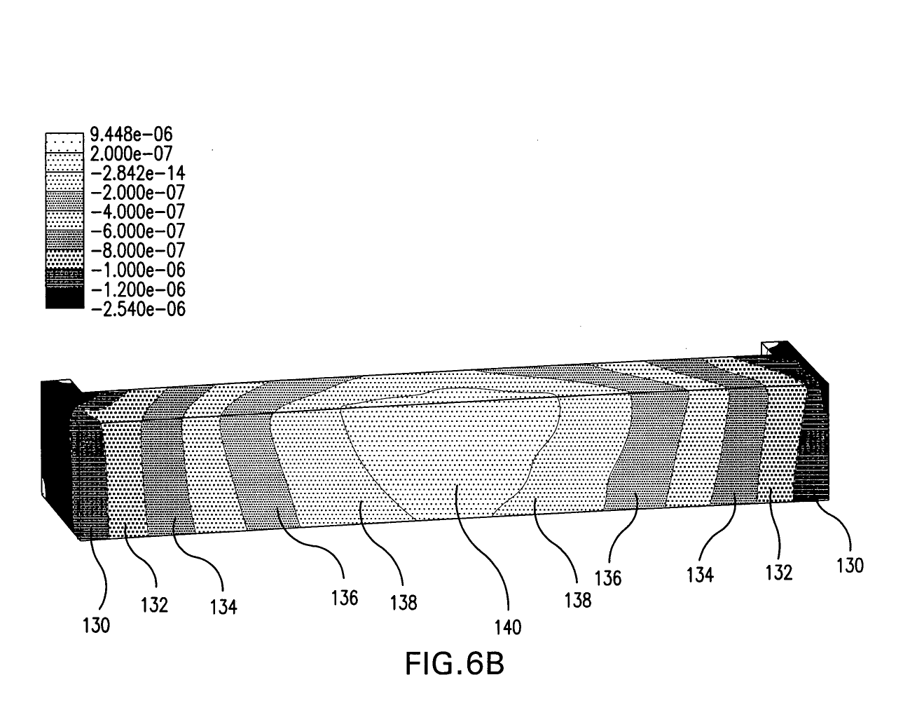

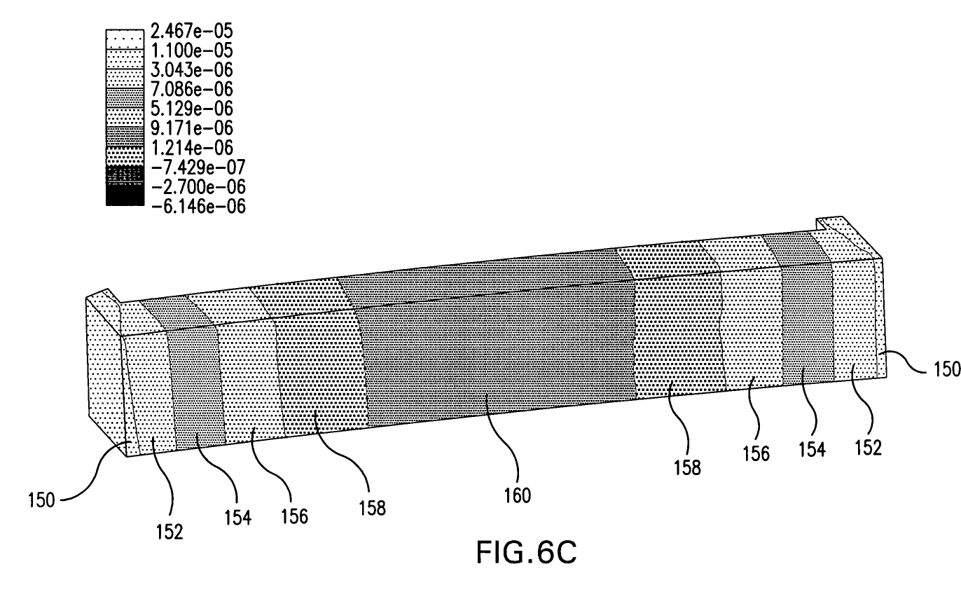

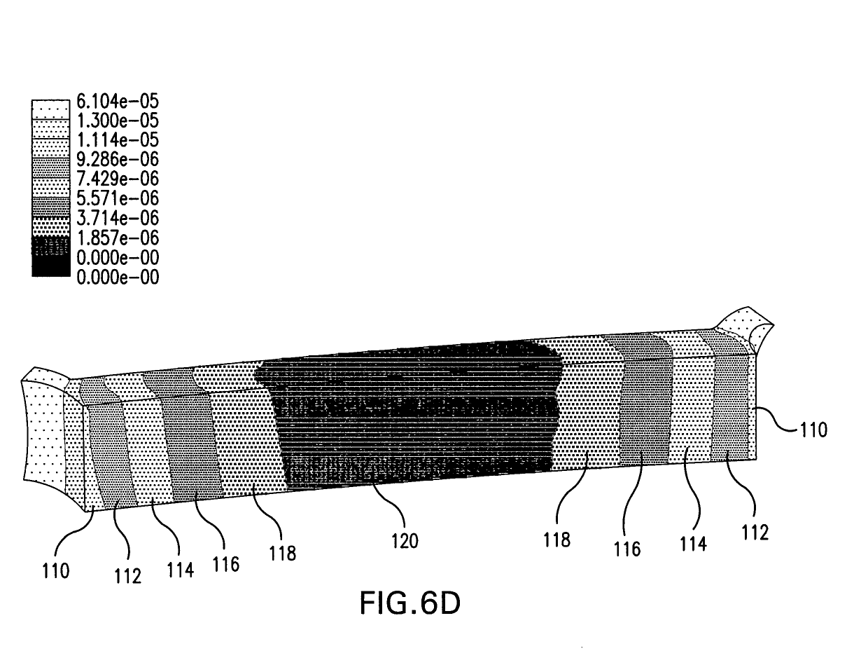

Turning Now to FIG. 6 there is shown a line narrowing module 10 according to an aspect of an embodiment of the present invention, which may contain within a line narrowing module housing 62 a prism assembly 64, and a grating assembly 66. The housing 62 may have a front plate 70, through which the LNM 10 is interfaced with the laser chamber (not shown) through a vibration isolating bellows 72. The prism assembly 64 may comprise, e.g., a 60× magnification prism beam expander, including, e.g., a first prism 82, a second prism 84, a third prism 86 and a fourth prism 88, e.g., each with a larger magnification factor, totaling, e.g., 60×. This 60× magnification beam expander 64 may serve to illuminate an extra long grating 90, which may comprise, e.g., a first grating portion 92 and a second grating portion 94, which are essentially identical in terms of length, number of grooves, and thus groove pitch, groove angle and blaze angle for the groves, etc., or may comprise one single piece elongated grating 90.

The grating 90, may be of a single monolithic construction and be distorted as discussed above or each of the separate portions 92, 94, where applicable, may be separately distorted so as to give the same effect as a single monolithic grating 90 being distorted as discussed above as one piece.

In addition, the LNM 10 may have added to it according to aspects of an embodiment of the present invention a variably refractive optical element 96 as explained in the above referenced co-pending patent application Ser. No. 10/956,784, referenced above. The insertable cylindrical lens 96 concept for producing the RELAX split spectrum can be used instead to affect a change in the FWHM and E95 value of the laser spectrum according to aspects of an embodiment of the present invention when the separation between the two speaks is set to a small value, e.g., smaller than the width of a single spectrum, so that the twin peaks are overlapping. The insertable cylindrical lens 96, according to another aspect of an embodiment of the present invention can be used in combination with the standard BCD to independently adjust both FWHM and E95 bandwidth values. Shown on FIG. 7 is a calculated effect on FWHM and E95 vs. peak shift caused by the cylindrical lens 96 and overlapping peaks, e.g., as shown in FIG. 9. Also shown in FIG. 7 is the calculated ratio of FWHM and E95.

A similar curve for the E95/FWHM ratio and absolute values vs. BCD setting is shown in FIG. 8. The data for FIGS. 7 and 8 was taken from different laser types and thus the bandwidth values are different, however, the data is illustrative of the tendencies of the above noted changes to affect different forms of bandwidth denomination, e.g., FWHM and E95.

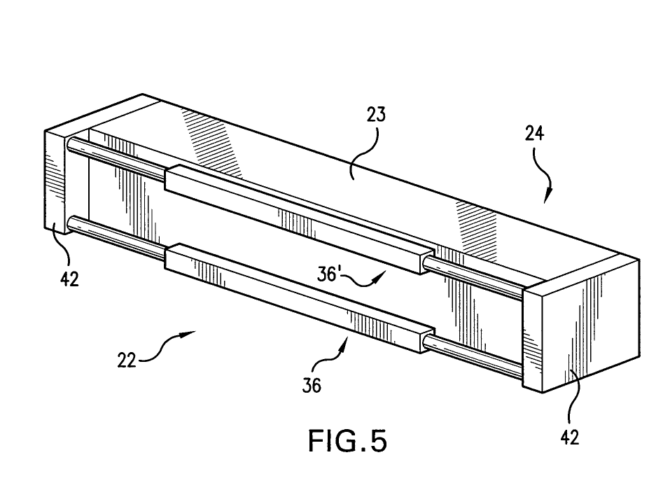

Applicants have considered certain problems within the LNM, e.g., relating to utilization of a larger grating and, e.g., scaling up the current BCD design to be used on a large grating. According to aspects of an embodiment of the present invention applicants propose using two parallel BCD's. Some of the problems are: a) increasing the load on the components and b) the accuracy of centering the BCD to the grating blank. The use of two parallel BCDs: a) reduces the forces on the individual components, but, more importantly, b) allows for a twist in the grating to be removed (or added) to fine tune bandwidth. Turning now to FIG. 5 there is shown an embodiment of the present invention in which two bandwidth control device force application units 36 and 36′ may be applied to the grating in parallel along the longitudinal axis of the grating 22, but spaced apart vertically, as that dimension is illustrated in the figure, from the longitudinal centerline axis of the grating. In this manner combinations of tensile and compressive force may be applied to the grating to distort the grating dispersive face 23, into various shapes, e.g., S-curves and the like. FIG. 's 6A-D illustrate different regions of displacement magnitude from a flat status on the dispersive face 24 of the grating, with the regions being as follows for FIG. 6A: 1.14 e⁻⁵-9.286 e⁻⁶ region 110, 9.286 e⁻⁶-7.429 e⁻⁶ region 112, 7.429 e⁻⁶ -5.571 e⁻⁶ region 114, 5.571 e⁻⁶-3.714 e⁻⁶ region 116, 3.714 e⁻⁶-1.857 e⁻⁶ region 118, 1.857 e⁻⁶-0.00 region 120, which as illustrated, extend across or partly across the side 23 of the grating 22; for FIG. 6B: −7.546 e⁻⁶- −1.200 e⁻⁶ region 128, −1.200 e⁻⁶-−1.100 e⁻⁶ region 130, −1.000 e⁻⁶-−8.000 e⁻⁷ region 132, −8.000 e⁻⁷-−6.000 e⁻⁷ region 134, −6.000 e⁻⁷-−4.000 e⁻⁷ region 136, −4.000 e⁻⁷-−2.000 e⁻⁷ region 138, −2.000 e⁻⁷-−2.842 e⁻¹⁴ region 140, −2.842 e⁻¹⁴-2.000 e ⁻⁷ region 142; for FIG. 6C: 1.100 e⁻⁵-3.043 e⁻⁶ region 150, 3.043 e⁻⁶-7.086 e⁻⁶ region 152, 7.086 e⁻⁶-5.129 e⁻⁶ region 154, 5.129 e⁻⁶-3.171 e⁻⁶ region 156, 3.171 e⁻⁶ -1.214 e⁻⁶ region 158, 1.214 e⁻⁶ -−7.429 e⁻⁷ region 160; and for FIG. 6D: 3.143 e⁻⁶-2.286 e⁻⁶ region 170, 2.286 e⁻⁶ -1.429 e⁻⁶ region 172, 1.429 e⁻⁶-5.714 e⁻⁷ region 174, 5.714 e⁻⁷-−2.057 e⁻⁷ region 176, −2.057 e⁻⁷-−1.143 e⁻⁶ region 178, −1.143 e⁻⁶ -−2.000 e⁻⁶ region 180, −2.000 e⁻⁶ -5.034 e⁻⁶ region 182.

The use of the larger grating 22, e.g., 60×60×360 mm allows room for two parallel BCD mechanisms 36, 36′ to be placed, e.g., on the side of the grating 22 away from the dispersive face 24 of the grating 22. The BCDs 36, 36′ can then create a moment on the grating 22 to bend it. By changing the relative forces between the two parallel BCD, a moment can be created in the plane parallel to the grating 22 dispersive face 24, inducing an optical twist to the grating 22, or correcting an inherent optical twist in the same grating 22, in either event, as necessary, acting to minimize adverse effects on the bandwidth of the laser light pulse beam returning from the dispersive face 24 of the grating 22. Optical twist can be an important figure of the grating 22 when determining it's performance. Control of the twist becomes more important for tighter bandwidth control requirements.

By changing the forces exerted by each BCD, a bend about the axis perpendicular to the grating face can be induced, which results in an “optical twist.” This can be used to minimize any inherent or induced twist of the grating 22. The next images show the deformation of the large grating face when a 5 Newton force (each side) is applied in expansion by the top BCD 36′ and a similar 3 Newton force also in expansion is applied by the bottom BCD 36. The 4 images show deformation in the X (FIG. 6D), Y (FIG. 6B), and Z (FIG. 6C) directions and the magnitude of the total deformation (FIG. 6A). The separation of the BCD is 50 mm.

For example according to an aspect of an embodiment of the present invention, in general, one can move both BCDs 36 an equal number of turns in the same direction and then fine tune one against the other, e.g., in opposite directions, e.g., using bandwidth as a metric.

According to an aspect of an embodiment of the present invention applicants propose a method for passive (no feedback) reduction in wavefront distortion by through, e.g., optical elements in the line narrowing module 10 and purge gas therein, partially compensating thermal induced optical nonuniformities. Adjustment in the LNM 10 for wavefront error, including grating 22 curvature adjustments as discussed herein serve to adjust for the distorted wavefront shape to minimize wavelength span (bandwidth) within divergence of the beam. Absorption of optical energy by beam propagation media (CaF₂ prism(s) or chamber windows, or by purge gas) may lead to development of refractive index gradients contributing to such wavefront distortion. CaF₂ has negative dn/dT, while other materials suitable for transmission of DUV light at the required fluences, e.g., an amorphous form of silicon, e.g., fused silica have positive gradients. Fused silica has a gradient that is also about 10 times higher in magnitude. Applicants propose to utilize an optical configuration with CaF₂ parts potentially affected by thermal load from dissipated optical power adding a thin fused silica beam path insertion optic plate to the beam path near these parts to reduce the residual effects, e.g., thermal effects on a wavefront passing through the main optic. As a result fluctuations and distortions of the laser optical spectrum line narrowed output of the line narrowing module 10 are reduced.

To minimize Fresnel losses the surface of additional beam path insertion optic plate can be coated with an anti-reflective coating. Thickness of the beam insertion optic plate can be adjusted to be specific for each application and can be determined experimentally and should be approximately 1/10 of the thickness of the neighboring main optical element the distortions of which are meant to be corrected, e.g., a CaF₂ prism, which sees the highest fluence times the volume absorption coefficients ratio for each.

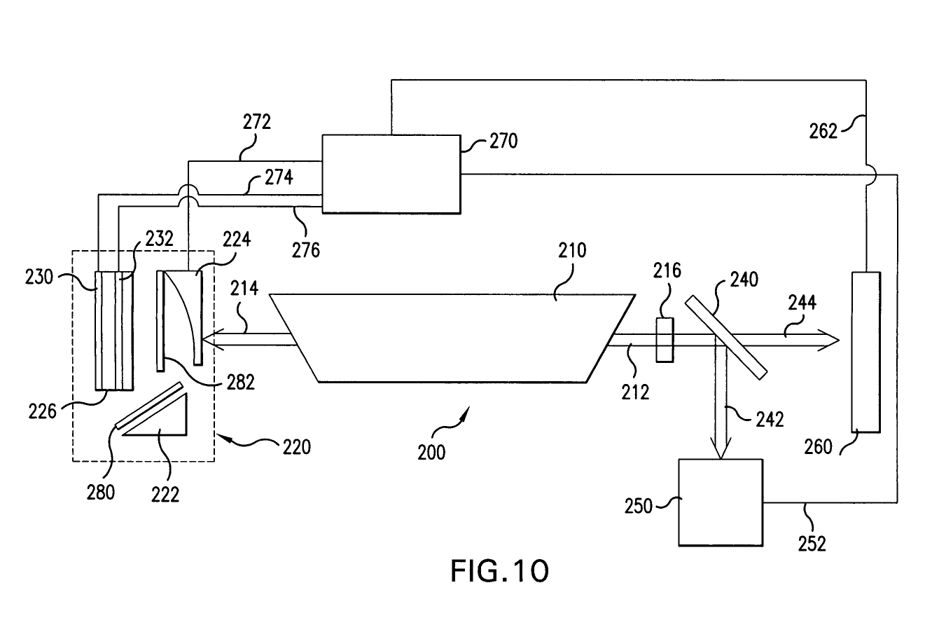

Turning now to FIG. 10 there is shown a plan partially schematic view of a laser system 200 according to aspects of an embodiment of the present invention which may comprise a chamber 210 forming part of a resonant cavity within which a laser beam laser beam 212, 214 resonates between an output coupler 216 and a line narrowing module 220. Shown schematically and not in exact position or to scale within the line narrowing module 220 are a beam expansion prism 222, an insertable cylindrical lens 224 and a grating 226. The grating 226 may have a grating bender 230 and a grating bender 232. The laser output light beam 244 may pas through a beam splitter 240 to form a split off beam sample 242 that may be directed to, among other metrology instruments, a wavemeter 250 where center wavelength(s) and bandwidth(s) may be measured or signals from which they may be measured or inferred may be generated by the wavemeter 250, e.g., generating a signal on signal line 252 to a controller 270. The laser output light pulse beam may also pass through another beam parameter detector 260, e.g., a wavefront detector, a power meter, a profile detector, or the like from which may put out a signal on signal line 262 to the controller 270. The controller may put out control signals, e.g., bandwidth control signals, e.g., on signal line 272 to control the insertion or withdrawal of the variably refractive optical element, e.g., the cylindrical lens 224 or on control signal line 274 and control signal line 276 to the respective grating bending elements 232, 230. The line narrowing module may also have a beam path insert plate 280, e.g., adjacent the prism 222 and/or a beam insert plate 282, e.g., adjacent the cylindrical lens 224, as discussed above with regard to aspects of an embodiment of the present invention.

Applicants propose another method for altering the wavefront shape which can, e.g., be applied inside a resonator of a line-narrowed laser to alter the spectral shape of the output light. The method enables, e.g., a different shape of wavefront deformation compared to other methods proposed for the same purpose. Therefore it is potentially useful for, e.g., controlling different spectral metrics (FWHM and E95) independently or quasi-independently, when used, e.g., in combination with another spectral control method. According to an aspect of an embodiment of the present invention an optical twister 200 may be employed which may comprise, e.g., two cylindrical telescopically arranged lenses 302, 304 of similar power, equal or nearly equal, and opposite-sign power may be used as is explained in more detail below. According to aspects of another embodiment of the present invention another approach may be to only one such lens, and the LNM 220 grating 22 with a BCD may be used to create a similar effect to that of the second lens—the BCD, e.g., is adjusted so that the LNM 220 has the same and opposite optical power as the lens. For example the grating 24 may be set further back from the chamber to account for the optical presence of the lens 202 as will be understood by those skilled in the art.

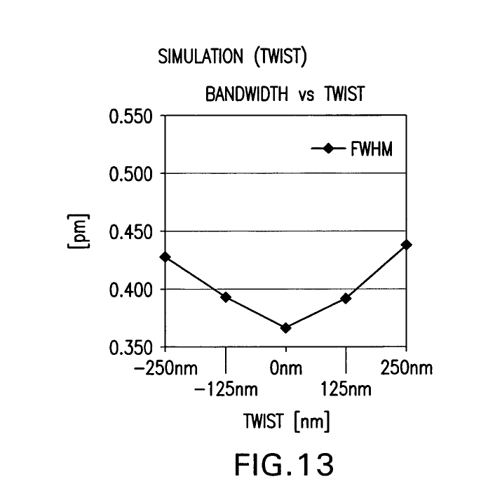

The lenses 202, 204 in first embodiment may be placed in close proximity to each other and anywhere in the laser cavity, i.e., between the output coupler and the line narrowing module wavelength selective optic, e.g., grating, and preferably according to aspects of an embodiment of the present invention between the laser chamber 210 and the line narrowing module 220. In the second embodiment a single rotationally mounted lens 302 may be placed in the cavity, e.g., between the LNM 220 and the chamber 210. The lens 302 may be mounted in a rotation stage allowing rotation about the beam direction, i.e., generally in the plane of the in the plane of laser beam pulse horizontal and vertical cross-section—corresponding to the height and width of the beam. The other lens 304 may be mounted in a fixed position, but also could be rotationally mounted. In the neutral position the cylinder axis of the lens(es) is vertical initially. In the first embodiment the opposite powers of the lenses compensate for each other and the net effect on the wavefront figure and bandwidth is zero. In the second embodiment the grating 24 curvature of the grating 22 is chosen such that it compensates for the wavefront deformation of the lens, and so the laser produces the same initial bandwidth as without any lenses and flat grating. To affect the wavefront, the rotatable lens 302 may be rotated so that its cylinder axis is no longer in the horizontal/vertical original or home position in one direction or another. A wavefront deformation and spectral shape change results from this introduction of nearly pure twist to the beam wavefront. Rotation in one direction, a positive direction or in another negative direction changes bandwidth FWHM nearly symmetrically, as shown in FIG. 13. A rotational actuator (not shown) may be tied via a feedback control system with a wavefront sensor or a bandwidth sensor 250 to produce a closed-loop system in order to maintain a constant bandwidth, or effect a desired bandwidth or wavefront change. Rotating both of the lenses 302, 304 in opposite directions produces a similar twist.

FIG. 12 shows an illustrative wavefront map in which the shaded zones 310-330 represent wavefront map for the telescope 300 with symmetrically rotated lenses and in waves at, e.g., 248 nm. The values are just exemplary of relative magnitude of the twist and in actuality depend on parameters of the lenses, wavelength, etc. The wavefront map is at about the dimensions of the beam, e.g., in a laser system of the 7XXX series as sold by applicants' assignee, Cymer, Inc., with the long axis being generally aligned to the horizontal in the LNM. The wavefront map contains 0.01-−0.01 region 310, 0.01-0.05 region 312, 0.05-0.10 region 314, 0.10-0.20 region 316, 0.20-0.30 region 317, 0.30-0.35 region 318, −0.30-−0.35 region 320 −0.20-−0.30 region 322, −0.10-−0.20 region 324, −0.10-−0.05 region 326 and −0.05-−0.01 region 328.

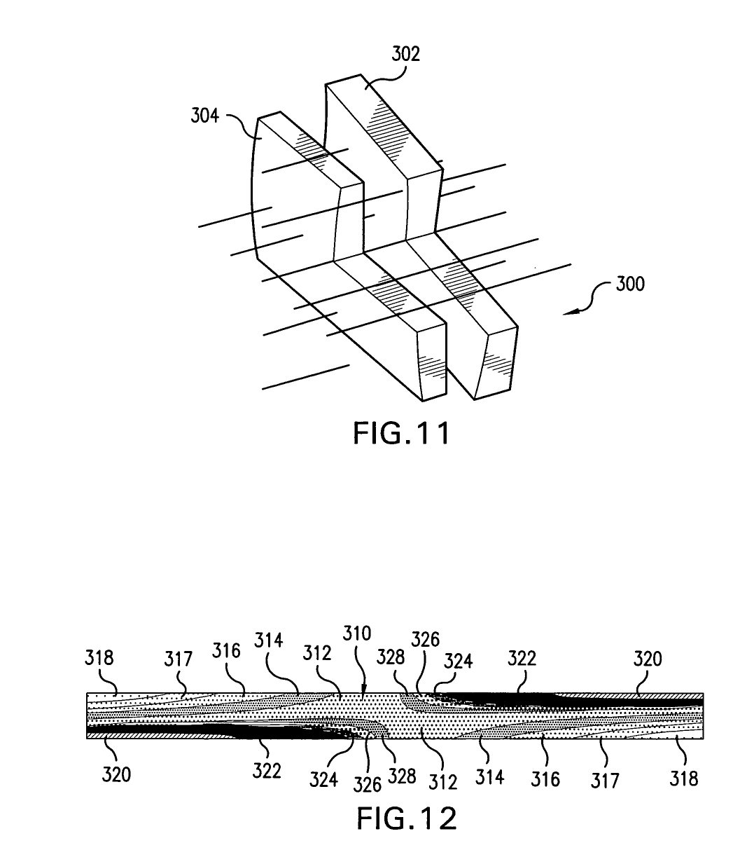

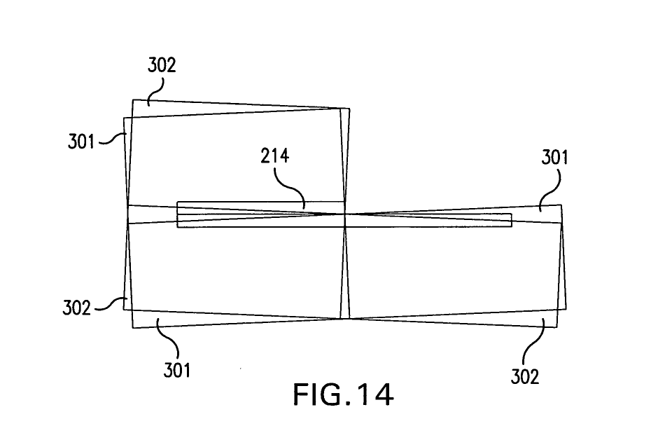

If only one lens 302, 304 is rotated, but the other lens 302, 304 (or bent grating as the case may be) stays at the same orientation with respect to an aperture, e.g., the aperture through which the beam passes in entering the line narrowing module 222, the wavefront deformation will have a vertical cylindrical component, which can change the vertical divergence and profile of the beam, which may be undesirable. This effect can be avoided in the case of the two-lens setup. If both lenses are rotated by the same angle in opposite directions as illustrated in FIG. 11 and FIG. 14 then the net effect of the two rotations on the vertical cylinder cancels out.

It will be understood by those skilled in the art from the foregoing that a line narrowing apparatus 220 and method for a narrow band DUV high power high repetition rate gas discharge laser 200 producing output laser light pulse beam pulses in bursts of pulses is disclosed, which may comprise a dispersive center wavelength selection optic, e.g., a grating 22 contained within a line narrowing module 220, selecting at least one center wavelength for each pulse determined at least in part by the angle of incidence of the laser light pulse beam containing the respective pulse on a dispersive wavelength selection optic 22 dispersive surface 24; a first dispersive optic bending mechanism operatively connected to the dispersive center wavelength selection optic 22 and operative to change the curvature of the dispersive surface 24 in a first manner, e.g., by either pushing or pulling on the grating at or about the center portion of the longitudinal dimension of the grating 24 or applying tension or compression to the ends of the grating curving the grating 22 in the longitudinal axis; and a second dispersive optic bending mechanism operatively connected to the dispersive center wavelength selection optic and operative to change the curvature of the dispersive surface in a second manner, e.g., from among those just mentioned. The first manner may modify a first measure of bandwidth and the second manner may modify a second measure of bandwidth such that the ratio of the first measure to the second measure substantially changes. The first measure may be a spectrum width at a selected percentage of the spectrum peak value (FWX % M) and the second measure may be width within which some selected percentage of the spectral intensity is contained (EX %). One manner may change the cylindrical curvature of the dispersive surface and the other manner may change the catenary curvature of the dispersive surface. At least one of the first and second bending mechanisms may be controlled by a wavefront controller during a burst based upon feedback from a beam parameter detector detecting a beam parameter in at least one other pulse in the burst of pulses and the controller providing the feedback based upon an algorithm employing the detected beam parameter for the at least one other pulse in the burst. The line narrowing module 220 may comprise a dispersive center wavelength selection optic 22 contained within a line narrowing module 220, selecting at least one center wavelength for each pulse determined at least in part by the angle of incidence of the laser light pulse beam containing the respective pulse on a dispersive wavelength selection optic 22 dispersive surface 24; a first dispersive optic bending mechanism operatively connected to the dispersive center wavelength selection optic and operative to change the curvature of the dispersive surface in a first dimension; a second dispersive optic bending mechanism operatively connected to the dispersive center wavelength selection optic and operative to change the curvature of the dispersive surface in a second dimension generally orthogonal to the first dimension. The change of curvature in the first dimension may modify a first measure of bandwidth and the change of curvature in the second dimension may modify a second measure of bandwidth such that the ratio of the first measure to the second measure substantially changes. The change of curvature in the first dimension may changes the cylindrical curvature in the first dimension and the change of curvature in the second dimension may change the cylindrical curvature in the second dimension, or the catenary curvature in the first dimension and the catenary curvature in the second dimension, or one of the cylindrical curvature and the catenary curvature in the first dimension and the other of the cylindrical and the catenary curvature in the second dimension. The narrow band DUV high power high repetition rate gas discharge laser 200 producing output laser light pulse beam pulses may comprise a beam path insert, e.g., 280 or 282 comprising a second material having a second index of refraction and a second index of refraction thermal gradient opposite from the first index of refraction thermal gradient and placed in the beam path and subject to essentially the same ambient environment as a neighboring optical element. The beam path insert, e.g., 280, 282 may comprise a thin plate. The first material may comprise MgF₂ and the second material may comprise an amorphous form of silicon, such as filsed silica. The optical elements may be selected from a group containing prisms, windows and dispersive optical elements. The beam path insert may have a surface of incidence and a surface of transmittance at least one of the surface of incidence and the surface of transmittance being coated with an anti-reflecting coating to minimize Fresnel losses through the beam path insert. The thickness of the beam path insert, e.g., 280, 282 may be selected based upon the thickness of the neighboring optical element, e.g., 222, 224, through which the highest fluence passes and the ratio of the volume absorption coefficient of the first material and the second material. The line narrowing module 220 may comprise a dispersive center wavelength selection optic 22 contained within a line narrowing module 220, selecting at least one center wavelength for each pulse determined at least in part by the angle of incidence of the laser light pulse beam containing the respective pulse on a dispersive wavelength selection optic dispersive surface; a first dispersive optic bending mechanism, e.g., 36 operatively connected to the dispersive center wavelength selection optic and operative to change the curvature of the dispersive surface in a first dimension; a second dispersive optic bending mechanism 36 operatively connected to the dispersive center wavelength selection optic and operative to change the curvature of the dispersive surface in a second dimension generally parallel to the first dimension. The laser system 200 for producing a narrow band DUV high power high repetition rate gas discharge laser output laser light pulse beam pulses in bursts of pulses may comprise a resonant lasing cavity 220, 210, ; a dispersive center wavelength selection optic contained within a line narrowing module, within the lasing cavity, selecting at least one center wavelength for each pulse determined at least in part by the angle of incidence of the laser light pulse beam containing the respective pulse on a dispersive wavelength selection optic dispersive surface; an optical beam twisting element in the lasing cavity optically twisting the laser light pulse beam to present a twisted wavefront to the dispersive center wavelength selection optic. The optical beam twisting element may comprises a first cylindrical lens and a second cylindrical lens in telescoping arrangement. At least one of the first and second cylindrical lens may be rotatable about a transverse centerline axis of the at least one of the first and second cylindrical lens. The first cylindrical lens may be rotatable about a transverse centerline axis of the first cylindrical lens and the second cylindrical lens may be rotatable about a transverse centerline axis of the second cylindrical lens. The line narrowing module for a narrow band DUV high power high repetition rate gas discharge laser producing output laser light pulse beam pulses in bursts of pulses may comprise a dispersive center wavelength selection optic contained within a line narrowing module, selecting at least one center wavelength for each pulse determined at least in part by the angle of incidence of the laser light pulse beam containing the respective pulse on a dispersive wavelength selection optic dispersive surface; a dispersive optic bending mechanism operatively connected to the dispersive center wavelength selection optic and operative to change the curvature of the dispersive surface; an optical bandwidth selection element operative to modify the effective spectrum of the laser light pulse beam by creating a first spectrum centered at a first center wavelength and a second spectrum centered at a second center wavelength separated from the first center wavelength by a selected displacement that is small enough for the first and the second spectra to substantially overlap. The optical bandwidth selection element may comprise a dithered tuning mirror that selects the first center wavelength for some pulses in a burst and the second center wavelength for other pulses in the burst to provide an effective integrated spectrum for the burst containing the two selected overlapping center wavelength spectra, or a variably refractive optical element that defines a first angle of incidence of a first portion of the laser light pulse beam on the dispersive wavelength selective optic and a second angle of incidence for a second portion of the laser light pulse beam, spatially separate from the first portion, on the dispersive wavelength selective optic. The variably refractive optical element may comprise a cylindrical lens having a longitudinal cylinder centerline axis generally parallel to a centerline axis of a cross section of the laser light pulse beam, and variably insertable into the path of the first portion of the laser light pulse beam. The bending mechanism primarily modifies a first measure of bandwidth and the optical bandwidth selection element primarily modifies a second measure of bandwidth. The first measure may be EX % and the second measure may be FWX % M.

It will be understood by those skilled in the art that the present invention may be modified in many ways without changing the scope of the appended claims and that the present application disclosed aspects of preferred embodiments of the present invention and the appended claims are not limited to such preferred embodiments alone. For example, while discussion has been made of modifying both FWHM and E95 measures of bandwidth utilizing a plurality of wavefront modifiers, the same techniques may also be useful in modifying/controlling just FWHM or just E95 to beneficial result, i.e., improvement of bandwidth control, i.e., maintenance with the selected range and/or pulse to pulse bandwidth stability. That is to say, while, e.g., imparting different curvatures and/or curvatures on different axes may have the above described beneficial effects the same techniques may also accommodate better control of a bandwidth measure, e.g., FYX % M or EX %, above and beyond currently available approaches to modifying/controlling bandwidth of the types of laser systems described in the present application. Furthermore, the laser optical wavefront twisting mechanism may have only one lens and still be beneficial for the above stated purposes of, e.g., controlling FWX % M and EX % independently and also for the better modification/control of one or the other or other measures of bandwidth alone as an improvement over existing techniques known in the art.

I/we claim:

1. A line narrowing module for a narrow band DUV high power high repetition rate gas discharge laser producing output laser light pulse beam pulses in bursts of pulses, comprising:
a dispersive center wavelength selection optic contained within a line narrowing module, selecting at least one center wavelength for each pulse determined at least in part by the angle of incidence of the laser light pulse beam containing the respective pulse on a dispersive wavelength selection optic dispersive surface;
a first dispersive optic bending mechanism operatively connected to the dispersive center wavelength selection optic and operative to change the curvature of the dispersive surface in a first manner; and,
a second dispersive optic bending mechanism operatively connected to the dispersive center wavelength selection optic and operative to change the curvature of the dispersive surface in a second manner.

2. The apparatus of claim 1 further comprising:
the first manner modifies a first measure of bandwidth and the second manner modifies a second measure of bandwidth such that the ratio of the first measure to the second measure substantially changes.

3. The apparatus of claim 2 further comprising:
the first measure is a spectrum width at a selected percentage of the spectrum peak value (FWX % M) and the second measure is a width within which some selected percentage of the spectral intensity is contained (EX %).

4. The apparatus of claim 1 further comprising:
the first manner changes the cylindrical curvature of the dispersive surface and the second manner changes the catenary curvature of the dispersive surface.

5. The apparatus of claim 2 further comprising:
the first manner changes the cylindrical curvature of the dispersive surface and the second manner changes the catenary curvature of the dispersive surface.

6. The apparatus of claim 3 further comprising:
the first manner changes the cylindrical curvature of the dispersive surface and the second manner changes the catenary curvature of the dispersive surface.

7. The apparatus of claim 1 further comprising:
at least one of the first and second bending mechanisms is controlled by a wavefront controller during a burst based upon feedback from a beam parameter detector detecting a beam parameter in at least one other pulse in the burst of pulses and the controller providing the feedback based upon an algorithm employing the detected beam parameter for the at least one other pulse in the burst.

8. The apparatus of claim 2 further comprising:
at least one of the first and second bending mechanisms is controlled by a wavefront controller during a burst based upon feedback from a beam parameter detector detecting a beam parameter in at least one other pulse in the burst of pulses and the controller providing the feedback based upon an algorithm employing the detected beam parameter for the at least one other pulse in the burst.

9. The apparatus of claim 3 further comprising:
at least one of the first and second bending mechanisms is controlled by a wavefront controller during a burst based upon feedback from a beam parameter detector detecting a beam parameter in at least one other pulse in the burst of pulses and the controller providing the feedback based upon an algorithm employing the detected beam parameter for the at least one other pulse in the burst.

10. The apparatus of claim 4 further comprising:
at least one of the first and second bending mechanisms is controlled by a wavefront controller during a burst based upon feedback from a beam parameter detector detecting a beam parameter in at least one other pulse in the burst of pulses and the controller providing the feedback based upon an algorithm employing the detected beam parameter for the at least one other pulse in the burst.

11. The apparatus of claim 5 further comprising:
at least one of the first and second bending mechanisms is controlled by a wavefront controller during a burst based upon feedback from a beam parameter detector detecting a beam parameter in at least one other pulse in the burst of pulses and the controller providing the feedback based upon an algorithm employing the detected beam parameter for the at least one other pulse in the burst.

12. The apparatus of claim 6 further comprising:
at least one of the first and second bending mechanisms is controlled by a wavefront controller during a burst based upon feedback from a beam parameter detector detecting a beam parameter in at least one other pulse in the burst of pulses and the controller providing the feedback based upon an algorithm employing the detected beam parameter for the at least one other pulse in the burst.

13. A line narrowing module for a narrow band DUV high power high repetition rate gas discharge laser producing output laser light pulse beam pulses in bursts of pulses, comprising:
a dispersive center wavelength selection optic contained within a line narrowing module, selecting at least one center wavelength for each pulse determined at least in part by the angle of incidence of the laser light pulse beam containing the respective pulse on a dispersive wavelength selection optic dispersive surface;
a first dispersive optic bending mechanism operatively connected to the dispersive center wavelength selection optic and operative to change the curvature of the dispersive surface in a first dimension;
a second dispersive optic bending mechanism operatively connected to the dispersive center wavelength selection optic and operative to change the curvature of the dispersive surface in a second dimension generally orthogonal to the first dimension.

14. The apparatus of claim 13 further comprising:
the change of curvature in the first dimension modifies a first measure of bandwidth and the change of curvature in the second dimension modifies a second measure of bandwidth such that the ratio of the first measure to the second measure substantially changes.

15. The apparatus of claim 14 further comprising:
the first measure is a spectrum width at a selected percentage of the spectrum peak value (FWX % M) and the second measure is a width within which some selected percentage of the spectral intensity is contained (EX %).

16. The apparatus of claim 13 further comprising:
at least one of the first and second bending mechanisms is controlled by a wavefront controller during a burst based upon feedback from a beam parameter detector detecting a beam parameter in at least one other pulse in the burst of pulses and the controller providing the feedback based upon an algorithm employing the detected beam parameter for the at least one other pulse in the burst.

17. The apparatus of claim 14 further comprising:
at least one of the first and second bending mechanisms is controlled by a wavefront controller during a burst based upon feedback from a beam parameter detector detecting a beam parameter in at least one other pulse in the burst of pulses and the controller providing the feedback based upon an algorithm employing the detected beam parameter for the at least one other pulse in the burst.

18. The apparatus of claim 15 further comprising:
at least one of the first and second bending mechanisms is controlled by a wavefront controller during a burst based upon feedback from a beam parameter detector detecting a beam parameter in at least one other pulse in the burst of pulses and the controller providing the feedback based upon an algorithm employing the detected beam parameter for the at least one other pulse in the burst.

19. The apparatus of claim 13 further comprising:
the change of curvature in the first dimension changes the cylindrical curvature in the first dimension and the change of curvature in the second dimension changes the cylindrical curvature in the second dimension.

20. The apparatus of claim 14 further comprising:
the change of curvature in the first dimension changes the cylindrical curvature in the first dimension and the change of curvature in the second dimension changes the cylindrical curvature in the second dimension.

21. The apparatus of claim 15 further comprising:
the change of curvature in the first dimension changes the cylindrical curvature in the first dimension and the change of curvature in the second dimension changes the cylindrical curvature in the second dimension.

22. The apparatus of claim 16 further comprising:
the change of curvature in the first dimension changes the cylindrical curvature in the first dimension and the change of curvature in the second dimension changes the cylindrical curvature in the second dimension.

23. The apparatus of claim 17 further comprising:
the change of curvature in the first dimension changes the cylindrical curvature in the first dimension and the change of curvature in the second dimension changes the cylindrical curvature in the second dimension.

24. The apparatus of claim 18 further comprising:
the change of curvature in the first dimension changes the cylindrical curvature in the first dimension and the change of curvature in the second dimension changes the cylindrical curvature in the second dimension.

25. The apparatus of claim 13 further comprising:
the change of curvature in the first dimension changes the catenary curvature in the first dimension and the change of curvature in the second dimension changes the catenary curvature in the second dimension.

26. The apparatus of claim 14 further comprising:
the change of curvature in the first dimension changes the catenary curvature in the first dimension and the change of curvature in the second dimension changes the catenary curvature in the second dimension.

27. The apparatus of claim 15 further comprising:
the change of curvature in the first dimension changes the catenary curvature in the first dimension and the change of curvature in the second dimension changes the catenary curvature in the second dimension.

28. The apparatus of claim 16 further comprising:
the change of curvature in the first dimension changes the catenary curvature in the first dimension and the change of curvature in the second dimension changes the catenary curvature in the second dimension.

29. The apparatus of claim 17 further comprising:
the change of curvature in the first dimension changes the catenary curvature in the first dimension and the change of curvature in the second dimension changes the catenary curvature in the second dimension.

30. The apparatus of claim 18 further comprising:
the change of curvature in the first dimension changes the catenary curvature in the first dimension and the change of curvature in the second dimension changes the catenary curvature in the second dimension.

31. The apparatus of claim 13 further comprising:
the change of curvature in the first dimension changes one of the cylindrical curvature and the catenary curvature in the first dimension and the change of curvature in the second dimension changes the other of the cylindrical and the catenary curvature in the second dimension.

32. The apparatus of claim 14 further comprising:
the change of curvature in the first dimension changes one of the cylindrical curvature and the catenary curvature in the first dimension and the change of curvature in the second dimension changes the other of the cylindrical and the catenary curvature in the second dimension.

33. The apparatus of claim 15 further comprising:
the change of curvature in the first dimension changes one of the cylindrical curvature and the catenary curvature in the first dimension and the change of curvature in the second dimension changes the other of the cylindrical and the catenary curvature in the second dimension.

34. The apparatus of claim 16 further comprising:
the change of curvature in the first dimension changes one of the cylindrical curvature and the catenary curvature in the first dimension and the change of curvature in the second dimension changes the other of the cylindrical and the catenary curvature in the second dimension.

35. The apparatus of claim 17 further comprising:
the change of curvature in the first dimension changes one of the cylindrical curvature and the catenary curvature in the first dimension and the change of curvature in the second dimension changes the other of the cylindrical and the catenary curvature in the second dimension.

36. The apparatus of claim 18 further comprising:
the change of curvature in the first dimension changes one of the cylindrical curvature and the catenary curvature in the first dimension and the change of curvature in the second dimension changes the other of the cylindrical and the catenary curvature in the second dimension.

37. A narrow band DUV high power high repetition rate gas discharge laser producing output laser light pulse beam pulses having a line narrowing module having a nominal optical path containing optical elements comprising a first material having a first index of refraction and a first index of refraction thermal gradient, comprising:
a beam path insert comprising a second material having a second index of refraction and a second index of refraction thermal gradient opposite from the first index of refraction thermal gradient and placed in the beam path and subject to essentially the same ambient environment as a neighboring optical element.

38. The apparatus of claim 37 further comprising:
the beam path insert comprising a thin plate.

39. The apparatus of claim 37 further comprising:
the first material comprising MgF₂ and the second material comprising an amorphous form of silicon.

40. The apparatus of claim 38 further comprising:
the first material comprising MgF₂ and the second material comprising an amorphous form of silicon.

41. The apparatus of claim 37 further comprising:
the second material comprising fused silica.

42. The apparatus of claim 38 further comprising:
the second material comprising fused silica.

43. The apparatus of claim 37 further comprising:
the optical elements are selected from a group containing prisms, windows and dispersive optical elements.

44. The apparatus of claim 38 further comprising:
the optical elements are selected from a group containing prisms, windows and dispersive optical elements.

45. The apparatus of claim 39 further comprising:
the optical elements are selected from a group containing prisms, windows and dispersive optical elements.

46. The apparatus of claim 40 further comprising:
the optical elements are selected from a group containing prisms, windows and dispersive optical elements.

47. The apparatus of claim 41 further comprising:
the optical elements are selected from a group containing prisms, windows and dispersive optical elements.

48. The apparatus of claim 42 further comprising:
the optical elements are selected from a group containing prisms, windows and dispersive optical elements.

49. The apparatus of claim 43 further comprising:
the beam path insert having a surface of incidence and a surface of transmittance at least one of the surface of incidence and the surface of transmittance being coated with an anti-reflecting coating to minimize Fresnel losses through the beam path insert.

50. The apparatus of claim 44 further comprising:
the beam path insert having a surface of incidence and a surface of transmittance at least one of the surface of incidence and the surface of transmittance being coated with an anti-reflecting coating to minimize Fresnel losses through the beam path insert.

51. The apparatus of claim 45 further comprising:
the beam path insert having a surface of incidence and a surface of transmittance at least one of the surface of incidence and the surface of transmittance being coated with an anti-reflecting coating to minimize Fresnel losses through the beam path insert.

52. The apparatus of claim 46 further comprising:
the beam path insert having a surface of incidence and a surface of transmittance at least one of the surface of incidence and the surface of transmittance being coated with an anti-reflecting coating to minimize Fresnel losses through the beam path insert.

53. The apparatus of claim 47 further comprising:
the beam path insert having a surface of incidence and a surface of transmittance at least one of the surface of incidence and the surface of transmittance being coated with an anti-reflecting coating to minimize Fresnel losses through the beam path insert.

54. The apparatus of claim 48 further comprising:
the beam path insert having a surface of incidence and a surface of transmittance at least one of the surface of incidence and the surface of transmittance being coated with an anti-reflecting coating to minimize Fresnel losses through the beam path insert.

55. The apparatus of claim 49 further comprising:
the thickness of the beam path insert being selected based upon the thickness of the neighboring optical element through which the highest fluence passes and the ratio of the volume absorption coefficient of the first material and the second material.

56. The apparatus of claim 50 further comprising:
the thickness of the beam path insert being selected based upon the thickness of the neighboring optical element through which the highest fluence passes and the ratio of the volume absorption coefficient of the first material and the second material.

57. The apparatus of claim 51 further comprising:
the thickness of the beam path insert being selected based upon the thickness of the neighboring optical element through which the highest fluence passes and the ratio of the volume absorption coefficient of the first material and the second material.

58. The apparatus of claim 52 further comprising:
the thickness of the beam path insert being selected based upon the thickness of the neighboring optical element through which the highest fluence passes and the ratio of the volume absorption coefficient of the first material and the second material.

59. The apparatus of claim 53 further comprising:
the thickness of the beam path insert being selected based upon the thickness of the neighboring optical element through which the highest fluence passes and the ratio of the volume absorption coefficient of the first material and the second material.

60. The apparatus of claim 54 further comprising:
the thickness of the beam path insert being selected based upon the thickness of the neighboring optical element through which the highest fluence passes and the ratio of the volume absorption coefficient of the first material and the second material.

61. A line narrowing module for a narrow band DUV high power high repetition rate gas discharge laser producing output laser light pulse beam pulses in bursts of pulses, comprising:
a dispersive center wavelength selection optic contained within a line narrowing module, selecting at least one center wavelength for each pulse determined at least in part by the angle of incidence of the laser light pulse beam containing the respective pulse on a dispersive wavelength selection optic dispersive surface;
a first dispersive optic bending mechanism operatively connected to the dispersive center wavelength selection optic and operative to change the curvature of the dispersive surface in a first dimension;
a second dispersive optic bending mechanism operatively connected to the dispersive center wavelength selection optic and operative to change the curvature of the dispersive surface in a second dimension generally parallel to the first dimension.

62. The apparatus of claim 61 further comprising:
the change of curvature in the first dimension is a change in the cylindrical curvature and change of curvature in the second dimension is a change in the cylindrical curvature.

63. The apparatus of claim 61 further comprising:
the change in curvature in the first dimension is of the catenary curvature and the change of curvature in the second dimension is of the catenary curvature.

64. The apparatus of claim 61 further comprising:
the change of curvature in the first dimension is of one of the cylindrical curvature and the catenary curvature and the change of curvature in the second dimension is the other of the cylindrical and catenary curvature.

65. The apparatus of claim 61 further comprising:
the change of curvature in the first dimension modifies a first measure of bandwidth and the change of curvature in the second dimension modifies a second measure of bandwidth such that the ratio of the first measure to the second measure substantially changes.

66. The apparatus of claim 62 further comprising:
the change of curvature in the first dimension modifies a first measure of bandwidth and the change of curvature in the second dimension modifies a second measure of bandwidth such that the ratio of the first measure to the second measure substantially changes.

67. The apparatus of claim 63 further comprising:
the change of curvature in the first dimension modifies a first measure of bandwidth and the change of curvature in the second dimension modifies a second measure of bandwidth such that the ratio of the first measure to the second measure substantially changes.

68. The apparatus of claim 64 further comprising:
the change of curvature in the first dimension modifies a first measure of bandwidth and the change of curvature in the second dimension modifies a second measure of bandwidth such that the ratio of the first measure to the second measure substantially changes.

69. The apparatus of claim 65 further comprising:
the first measure is a spectrum width at a selected percentage of the spectrum peak value (FWX % M) and the second measure is a width within which some selected percentage of the spectral intensity is contained (EX %).

70. The apparatus of claim 66 further comprising:
the first measure is a spectrum width at a selected percentage of the spectrum peak value (FWX % M) and the second measure is a width within which some selected percentage of the spectral intensity is contained (EX %).

71. The apparatus of claim 67 further comprising:
the first measure is a spectrum width at a selected percentage of the spectrum peak value (FWX % M) and the second measure is a width within which some selected percentage of the spectral intensity is contained (EX %).

72. The apparatus of claim 68 further comprising:
the first measure is a spectrum width at a selected percentage of the spectrum peak value (FWX % M) and the second measure is a width within which some selected percentage of the spectral intensity is contained (EX %).

73. The apparatus of claim 61 further comprising:
at least one of the first and second bending mechanisms is controlled by a wavefront controller during a burst based upon feedback from a beam parameter detector detecting a beam parameter in at least one other pulse in the burst of pulses and the controller providing the feedback based upon an algorithm employing the detected beam parameter for the at least one other pulse in the burst.

74. The apparatus of claim 62 further comprising:
at least one of the first and second bending mechanisms is controlled by a wavefront controller during a burst based upon feedback from a beam parameter detector detecting a beam parameter in at least one other pulse in the burst of pulses and the controller providing the feedback based upon an algorithm employing the detected beam parameter for the at least one other pulse in the burst.

75. The apparatus of claim 63 further comprising:
at least one of the first and second bending mechanisms is controlled by a wavefront controller during a burst based upon feedback from a beam parameter detector detecting a beam parameter in at least one other pulse in the burst of pulses and the controller providing the feedback based upon an algorithm employing the detected beam parameter for the at least one other pulse in the burst.

76. The apparatus of claim 64 further comprising:
at least one of the first and second bending mechanisms is controlled by a wavefront controller during a burst based upon feedback from a beam parameter detector detecting a beam parameter in at least one other pulse in the burst of pulses and the controller providing the feedback based upon an algorithm employing the detected beam parameter for the at least one other pulse in the burst.

77. The apparatus of claim 65 further comprising:
at least one of the first and second bending mechanisms is controlled by a wavefront controller during a burst based upon feedback from a beam parameter detector detecting a beam parameter in at least one other pulse in the burst of pulses and the controller providing the feedback based upon an algorithm employing the detected beam parameter for the at least one other pulse in the burst.

78. The apparatus of claim 66 further comprising:
at least one of the first and second bending mechanisms is controlled by a wavefront controller during a burst based upon feedback from a beam parameter detector detecting a beam parameter in at least one other pulse in the burst of pulses and the controller providing the feedback based upon an algorithm employing the detected beam parameter for the at least one other pulse in the burst.

79. The apparatus of claim 67 further comprising:
at least one of the first and second bending mechanisms is controlled by a wavefront controller during a burst based upon feedback from a beam parameter detector detecting a beam parameter in at least one other pulse in the burst of pulses and the controller providing the feedback based upon an algorithm employing the detected beam parameter for the at least one other pulse in the burst.

80. The apparatus of claim 68 further comprising:
at least one of the first and second bending mechanisms is controlled by a wavefront controller during a burst based upon feedback from a beam parameter detector detecting a beam parameter in at least one other pulse in the burst of pulses and the controller providing the feedback based upon an algorithm employing the detected beam parameter for the at least one other pulse in the burst.

81. The apparatus of claim 69 further comprising:
at least one of the first and second bending mechanisms is controlled by a wavefront controller during a burst based upon feedback from a beam parameter detector detecting a beam parameter in at least one other pulse in the burst of pulses and the controller providing the feedback based upon an algorithm employing the detected beam parameter for the at least one other pulse in the burst.

82. The apparatus of claim 70 further comprising:
at least one of the first and second bending mechanisms is controlled by a wavefront controller during a burst based upon feedback from a beam parameter detector detecting a beam parameter in at least one other pulse in the burst of pulses and the controller providing the feedback based upon an algorithm employing the detected beam parameter for the at least one other pulse in the burst.

83. The apparatus of claim 71 further comprising:
at least one of the first and second bending mechanisms is controlled by a wavefront controller during a burst based upon feedback from a beam parameter detector detecting a beam parameter in at least one other pulse in the burst of pulses and the controller providing the feedback based upon an algorithm employing the detected beam parameter for the at least one other pulse in the burst.

84. The apparatus of claim 72 further comprising:
at least one of the first and second bending mechanisms is controlled by a wavefront controller during a burst based upon feedback from a beam parameter detector detecting a beam parameter in at least one other pulse in the burst of pulses and the controller providing the feedback based upon an algorithm employing the detected beam parameter for the at least one other pulse in the burst.

85. A narrow band DUV high power high repetition rate gas discharge laser producing output laser light pulse beam pulses in bursts of pulses, comprising:
a resonant lasing cavity;
a dispersive center wavelength selection optic contained within a line narrowing module, within the lasing cavity, selecting at least one center wavelength for each pulse determined at least in part by the angle of incidence of the laser light pulse beam containing the respective pulse on a dispersive wavelength selection optic dispersive surface;
an optical beam twisting element in the lasing cavity optically twisting the laser light pulse beam to present a twisted wavefront to the dispersive center wavelength selection optic.

86. The apparatus of claim 85 further comprising:
the optical beam twisting element comprises a first cylindrical lens and a second cylindrical lens in telescoping arrangement.

87. The apparatus of claim 86 further comprising:
at least one of the first and second cylindrical lens is rotatable about a transverse centerline axis of the at least one of the first and second cylindrical lens.

88. The apparatus of claim 86 further comprising:
the first cylindrical lens is rotatable about a transverse centerline axis of the first cylindrical lens and the second cylindrical lens is rotatable about a transverse centerline axis of the second cylindrical lens.

89. A line narrowing module for a narrow band DUV high power high repetition rate gas discharge laser producing output laser light pulse beam pulses in bursts of pulses, comprising:
a dispersive center wavelength selection optic contained within a line narrowing module, selecting at least one center wavelength for each pulse determined at least in part by the angle of incidence of the laser light pulse beam containing the respective pulse on a dispersive wavelength selection optic dispersive surface;
a dispersive optic bending mechanism operatively connected to the dispersive center wavelength selection optic and operative to change the curvature of the dispersive surface;
an optical bandwidth selection element operative to modify the effective spectrum of the laser light pulse beam by creating a first spectrum centered at a first center wavelength and a second spectrum centered at a second center wavelength separated from the first center wavelength by a selected displacement that is small enough for the first and the second spectra to substantially overlap.

90. The apparatus of claim 89 further comprising:
the optical bandwidth selection element comprises a dithered tuning mechanism that selects the first center wavelength for some pulses in a burst and the second center wavelength for other pulses in the burst to provide an effective integrated spectrum for the burst containing the two selected overlapping center wavelength spectra.

91. The apparatus of claim 89 further comprising:
the optical bandwidth selection element comprises a variably refractive optical element that defines a first angle of incidence of a first portion of the laser light pulse beam on the dispersive wavelength selective optic and a second angle of incidence for a second portion of the laser light pulse beam, spatially separate from the first portion, on the dispersive wavelength selective optic.

92. The apparatus of claim 91 further comprising:
the variably refractive optical element comprises a cylindrical lens having a longitudinal cylinder centerline axis generally parallel to a centerline axis of a cross section of the laser light pulse beam, and variably insertable into the path of the first portion of the laser light pulse beam.

93. The apparatus of claim 89 further comprising:
the bending mechanism primarily modifies a first measure of bandwidth and the optical bandwidth selection element primarily modifies a second measure of bandwidth.

94. The apparatus of claim 90 further comprising:
the bending mechanism primarily modifies a first measure of bandwidth and the optical bandwidth selection element primarily modifies a second measure of bandwidth.

95. The apparatus of claim 91 further comprising:
the bending mechanism primarily modifies a first measure of bandwidth and the optical bandwidth selection element primarily modifies a second measure of bandwidth.

96. The apparatus of claim 92 further comprising:
the bending mechanism primarily modifies a first measure of bandwidth and the optical bandwidth selection element primarily modifies a second measure of bandwidth.

97. The apparatus of claim 93 further comprising:
the first measure is EX % and the second measure is FWX % M.

98. The apparatus of claim 94 further comprising:
the first measure is EX % and the second measure is FWX % M.

99. The apparatus of claim 95 further comprising:
the first measure is EX % and the second measure is FWX % M.

100. The apparatus of claim 96 further comprising:
the first measure is EX % and the second measure is FWX % M.

101. A method of line narrowing for a narrow band DUV high power high repetition rate gas discharge laser producing output laser light pulse beam pulses in bursts of pulses, comprising:
using a dispersive center wavelength selection optic contained within a line narrowing module, selecting at least one center wavelength for each pulse determined at least in part by the angle of incidence of the laser light pulse beam containing the respective pulse on a dispersive wavelength selection optic dispersive surface;
using a first dispersive optic bending mechanism operatively connected to the dispersive center wavelength selection optic, changing the curvature of the dispersive surface in a first manner; and,
using a second dispersive optic bending mechanism operatively connected to the dispersive center wavelength selection optic, changing the curvature of the dispersive surface in a second manner.

102. A line narrowing module for a narrow band DUV high power high repetition rate gas discharge laser producing output laser light pulse beam pulses in bursts of pulses, comprising:
a dispersive center wavelength selection optic contained within a line narrowing module, selecting at least one center wavelength for each pulse determined at least in part by the angle of incidence of the laser light pulse beam containing the respective pulse on a dispersive wavelength selection optic dispersive surface;
a first dispersive optic bending mechanism operatively connected to the dispersive center wavelength selection optic and operative to change the curvature of the dispersive surface in a selected manner manner; and,
a second dispersive optic bending mechanism operatively connected to the dispersive center wavelength selection optic and operative to change the curvature of the dispersive surface in the selected manner.

103. A line narrowing module for a narrow band DUV high power high repetition rate gas discharge laser producing output laser light pulse beam pulses in bursts of pulses, comprising:
a dispersive center wavelength selection optic contained within a line narrowing module, selecting at least one center wavelength for each pulse determined at least in part by the angle of incidence of the laser light pulse beam containing the respective pulse on a dispersive wavelength selection optic dispersive surface;
a first laser light pulse beam wavefront modifier operative to change the wavefront of the laser light pulse beam in a selected manner; and,
a second laser light pulse-wavefront modifier operative to change the wavefront of the laser light pulse beam in the selected manner.
